(19) United States
(12) Patent Application Publication
(10) Pub. No.: US 2008/0008318 A1
(43) Pub. Date: Jan. 10, 2008

(54) Image Forming Apparatus and Document Management System

(75) Inventor: Mitsuhiro KINOSHITA, Shizuoka-ken (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Shinagawa-ku (JP)

(21) Appl. No.: 11/456,563

(22) Filed: Jul. 10, 2006

(51) Int. Cl. H04N 7/167

(52) U.S. Cl. 380/217

(57) ABSTRACT

An image forming apparatus has a scanner capable of reading, from an original having a wireless tag unit attached thereto, an original image and data stored in the wireless tag unit. The original image read by the scanner can be duplicated by a duplicating unit. Moreover, a user who can use the image forming apparatus is preset, and user information representing a security level for user is registered into a database in advance. When a user executed duplication of an original, user authentication is performed on the basis of the user information registered in the database. If data of a security level for management is stored in the wireless tag unit, the security level for user is compared with the security level for management, and also in accordance with the result of the user authentication, it is determined whether duplication of the original is permitted or not. Thus, the duplication is permitted or prohibited. When the duplication is permitted, the duplication can be carried out using the preset processing function.

### BACKGROUND OF THE INVENTION

1. Field of the Invention

This invention relates to an image forming apparatus including MFP (multi-function peripherals), which are digital multi-function machines, and copy machines, and to a document management system, and realizes improved security therein.

2. Description of the Related Art

Generally, some image forming apparatuses such as MFP and copy machines have multiple functions including a copy function, scanning function and the like. In such a multi-function image forming apparatus, when copying the same image data plural times, or when scanning, image data is temporarily stored into a storage device such as HDD, and the image data is read out from this storage device and outputted by a printer. Also, an MFP and a PC (personal computer) may be connected via a network, and image data created by the PC may be printed by the MFP, or image data scanned and read by the MFP may be sent to the PC.

Meanwhile, in an image forming apparatus, since image data remains in its HDD (storage device), there is a problem in view of keeping confidentiality of the image data. Therefore, the image data is erased by overwriting the HDD or access limitation is made by user authentication, thereby improving security.

On the other hand, security measures for printed matter are difficult, and it is a task to restrain and prevent leakage of information from paper documents and their duplicates.

JP-A-2005-31791 discloses a copyright control system that uses a wireless tag for preventing unauthorized copying of publications and data. In this example, a wireless tag having an identification code written therein is attached to an original, and the identification code in the wireless tag is read when this original is copied. The read identification code is sent to a copyright control server via a network, and an inquiry is made about whether the original can be copied or not, thereby preventing unauthorized copying.

JP-A-2005-35095 discloses a document management system that uses a paper in which a wireless tag is embedded. In this example, the identifier of the wireless tag embedded in the paper is read, and the read identifier is sent to a document management server to inquire whether the copying of the document is allowed or not.

Moreover, with respect to the image forming apparatus disclosed in JP-A-2005-31153, an example is described in which a wireless tag unit storing management information is attached to a recording medium so that radio communication is carried out between the wireless tag unit and the image forming apparatus. In this example, the management information is read from the wireless tag unit and execution of re-duplication is limited on the basis of the management information.

However, in the foregoing example, the limitation of duplication cannot be set in detail for each user.

This invention is to provide an image forming apparatus and its control method in which security is improved by controlling the limitation of duplication for each user, and a document management system.

### BRIEF DESCRIPTION OF THE DRAWINGS

FIG. 1 is a structural view showing a document management system including an image forming apparatus according to this invention.

FIG. 2 is a block diagram for explaining the configuration of the image forming apparatus according to this invention.

FIG. 3 is an explanatory view for explaining an exemplary use of a wireless tag unit that is used in the document management system according to this invention, and an example of data stored in the wireless tag unit.

FIG. 4 is an explanatory view for explaining an example of user information stored in a server of the document management system according to this invention.

FIG. 5 is a flowchart for explaining the operation of the document management system according to this invention.

### DETAILED DESCRIPTION OF THE INVENTION

Throughout this description, the embodiment and example shown should be considered exemplars, rather than limitations on the apparatus and systems of the present invention.

Hereinafter, an embodiment of this invention will be described in detail with reference to the drawings. In the drawings, the same portion is denoted by the same numeral.

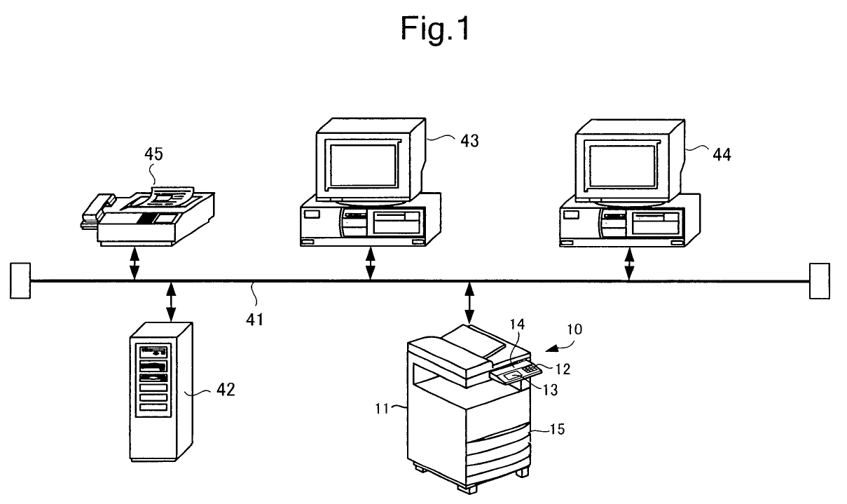

FIG. 1 is a structural view showing a document management system including an image forming apparatus according to this invention. In the following description, an example of using an MFP (multi-function peripheral) as an image forming apparatus will be described. However, the invention can also be applied to a copy machine or other image forming apparatuses.

In FIG. 1, 10 represents an MFP. An operating unit 12 is provided at a top part of a body 11 of the MFP. The operating unit 12 has various keys for setting operating conditions and includes, for example, a start key, ten key, copy key, scan key, print key, facsimile key, set/register key and the like. A display unit 13 of liquid crystal or the like is provided next to the operating unit 12. These operating unit 12 and display unit 13 are provided on an operating panel 14.

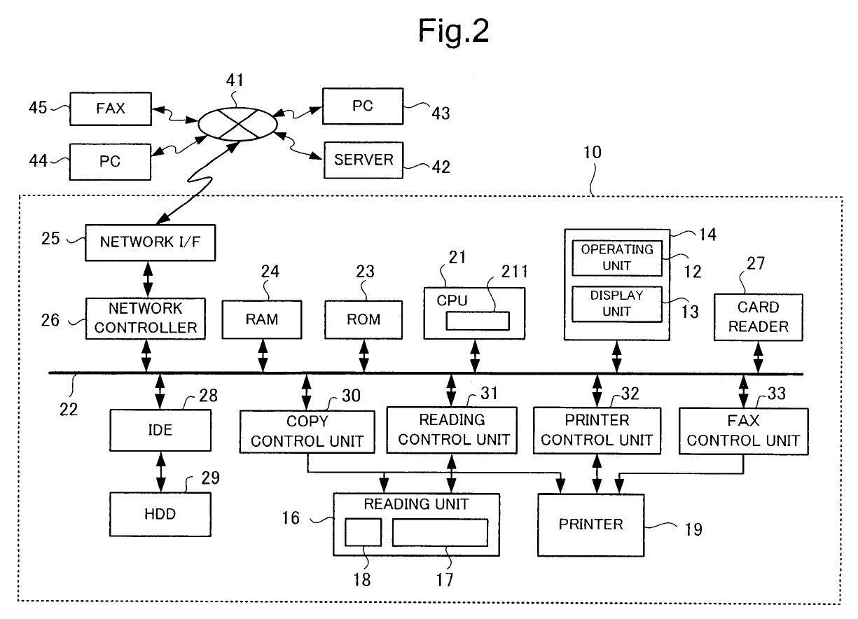

The MFP 10 has an original table provided at its top part, and an automatic document feeder (ADF) is provided to freely open and close on the original table. In a lower part of the body 11, cassettes 15 housing papers of various sizes are provided. Moreover, within the body 11, a reading unit 16 and a printer 19 shown in FIG. 2 are provided. The reading unit 16 has a scanner 17 that reads an original image, and a wireless tag reader 18 that reads information of a wireless tag unit.

In this invention, a wireless tag unit is attached to an original that is confidential, then the information stored in this wireless tag unit is read out, and duplication of the original is limited on the basis of the read information. The wireless tag reader 18 can read the information of the wireless tag unit.

The job functions of the image forming apparatus 10 include, for example, a printer function, scanning function, color copy function, network print function, fax function and the like.

The printer function is the function of printing image data. The scanning function includes the function of copying image data read by the scanner 17, the filing function of storing image data scanned in the body 11 to a PC (personal computer) or the like, which will be described later, and the mailing function of sending image data scanned in the body 11 in the form of E-mail to an external device. The network print function is the function of printing, on the body 11 side, image data sent to the body 11 from an external device. The fax function is the function of faxing image data.

As the functions of reading an original and performing duplication processing, the above-described copy function and filing function, and communication functions such as the mailing function and facsimile function are involved.

The MFP 10 is connectable to external devices via a network 41. The external devices include a server 42, PCs (personal computers) 43, 44, a facsimile device 45 and the like. For example, the PC 43 is a manager terminal and the PC 44 is a general user terminal.

FIG. 2 is a block diagram showing the configuration of the image forming apparatus 10.

A CPU 21 is provided in the image forming apparatus 10. The CPU 21 includes a control unit 211 and is connected to a PCI bus 22. PCI bus is an abbreviation of Peripheral Component Interconnect Bus. A ROM (read-only memory) 23 and a RAM (random access memory) 24 are connected to the PCI bus 22. In the ROM 22, various control program data necessary for the operations of the body 11 are stored. The RAM 23 stores control information for the operation of each unit.

Also, a network interface 25 is provided in the image forming apparatus 10. The network interface 25 is connected to the PCI bus 22 via a network controller 26. The network interface 25 includes a LAN board, FAX modem and the like, and is connected to external devices, for example, the server 42, PC 43, PC 44 and facsimile device 45, via the network 41 The network controller 26 controls data exchange with the external devices via the network interface 25. In the server 42 connected to the network 41, a database is provided that defines role information for each user, which will be described later.

Also, a card reader 27 is connected to the PCI bus 22. The card reader 27 is used when determining whether an operator operating the MFP 10 is a regular user or not. A regular user possesses a card in which an identification code has been stored in advance. As the user holds the card over the MFP 10, the card reader 27 reads the identification code and the CPU 21 authenticates whether the user is a regular user or not. Alternatively, as a method for authenticating whether a user is a regular user or not, the user may operate the operating unit 12 to input the personal identification number.

Also the operating panel 14 is connected to the PCI bus 22. Moreover, an HDD (storage device) 29 is connected to the PCI bus 22 via an IDE 28. The IDE 28 is an interface for connecting the HDD 29 to the PCI bus 22, and IDE is an abbreviation of Integrated Device Electronics. The operating panel 14 includes the above-described operating unit 12 and display unit 13.

Additionally, a copy control unit 30, reading control unit 31, printer control unit 32, and fax control unit 33 are connected to the PCI bus 22. The control unit 211 of the CPU 21 constitutes a job management unit that controls the copy control unit 30, reading control unit 31, printer control unit 32 and fax control unit 33.

The copy control unit 30 controls the usual copy function using the reading unit 16 and the printer 19.

The reading control unit 31 controls the scanning function of reading an original using the scanner 17, the filing function of storing scanned image data to the PC 42, and the E-mailing function of sending image data to an external device. Moreover, the reading control unit 31 controls the reading of information of the wireless tag unit (described below) by the wireless tag reader 18.

The printer control unit 32 controls the print function using the printer 19 or the network print function. Moreover, the facsimile control unit 33 controls the facsimile function. Also, image data at the time of printing by the printer 19 is stored to the HDD 29.

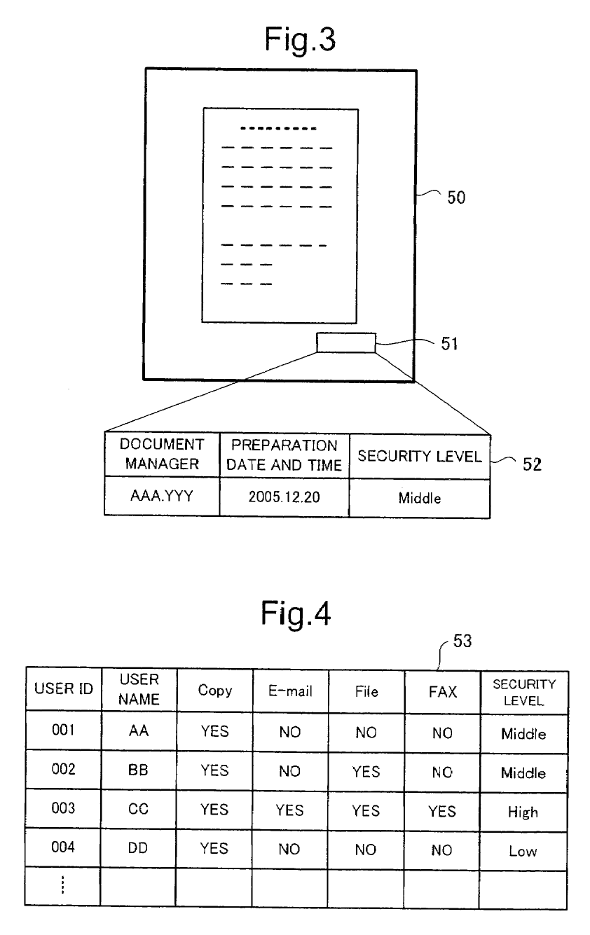

FIG. 3 is a view for explaining a wireless tag unit 51. The wireless tag unit 51 is used as it is attached to an original 50. The wireless tag unit 51 is called RFID (Radio Frequency Identification) and contains an IC chip for storing data and a communication antenna. Data as indicated by 52 in FIG. 3 is stored in the IC chip.

As the data 52, the document manager of the original to which the wireless tag unit 51 is attached, the preparation date of the document, security level and the like are stored. The security level is prescribed, for example, in three levels of “High”, “Middle” and “Low”. “High” refers to a top-secret document, “Middle” refers to a confidential document. “Low” refers to a normal document. However, the security level is not limited to the above three levels and can be prescribed in a larger number of levels.

FIG. 4 is a view for explaining an example of user information 53 stored in the server 42. The user information 53 includes type data representing an available processing function of the functions of the NFP 10, and data of security level defined for each user. In FIG. 4, user ID is set corresponding to a user name , and the respective function of the MFP 10, functions available to each user and functions unavailable to each user are set. “YES” in FIG. 4 shows available functions and “NO” shows unavailable functions.

The types of function include, for example, “Copy”, “E-mail”, “File” and “FAX”. “Copy” is the normal copy function. “E-mail” is the function of mailing image data acquired by scanning an original to a predetermined address. “File” is the function of taking image data acquired by scanning an original into the HDD 29 of the MFP 10 or to the PC 43. “FAX” is the function of faxing an image acquired by scanning an original. These functions can be used for duplicating an original.

In the example of FIG. 4, user AA can only use the processing function of “Copy”, and originals that this user can handle are limited to the security level “Middle” or below, that is, confidential documents and normal documents. User AA cannot handle top-secret documents of “High”. User CC can use the processing functions of “Copy”, “E-mail”, “File” and “FAX”, and can handle documents of the security level “High” or below, that is, top-secret documents, confidential documents and normal documents.

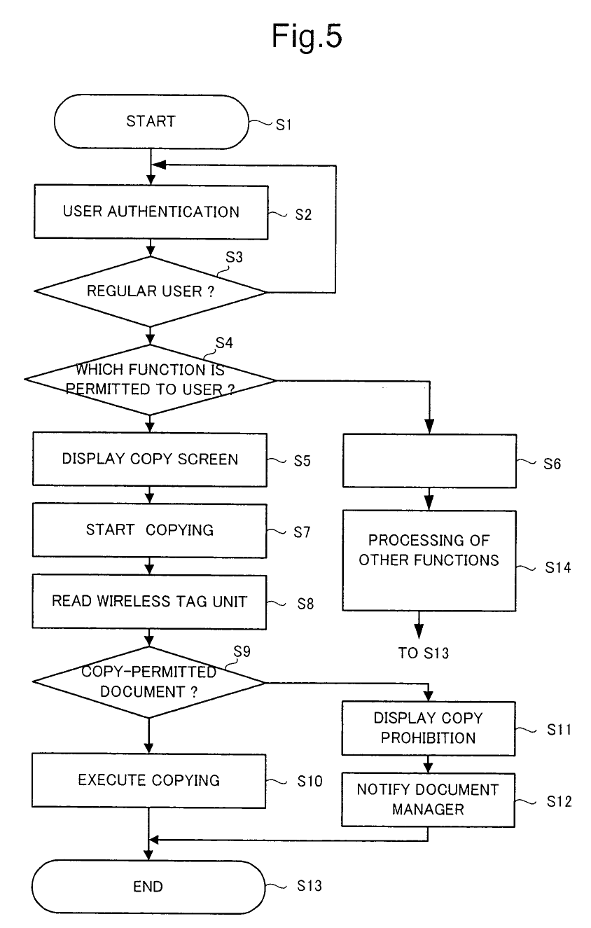

FIG. 5 is a flowchart for explaining the operation of the document management system using the image forming apparatus according to this invention, in the case of copying an original with the wireless tag unit 51 attached thereto.

In FIG. 5, step S1 is an operation start step. In step S2, user authentication is carried out. User authentication is to determine whether the operator operating the MFP 10 is a regular user or not. As a regular user holds a card storing an identification code in advance over the MFP 10, the card reader 27 reads the identification code.

The read identification code is transferred to the server 42 via the network 41 and an inquiry is made about whether the user is a regular user or not (step S3) If the user is a regular user, the security level of the user in question is sent back on the basis of the user information 53 (FIG. 4) stored in the server. If it is determined that the user is not a regular user, the processing returns to step S2.

In step S4, the function permitted to the user is discriminated. For example, if the copy function is permitted to the user, a screen for copy operation (copy screen) is displayed in step S5. On the other hand, if the copy function is not permitted to the user, the processing shifts to step S6 and a screen of a permitted mode other than copy is displayed.

Next, in step S7, as the original 50 with the wireless tag unit 51 attached thereto is set on the original table and the operating unit 12 is operated to press the copy key, the copy operation starts and the scanner 17 reads the original. At the same time, in step S8, the wireless tag reader 18 reads the data 52 written in the wireless tag unit 51.

Next, in step S9, the security level received from the server 42 is compared with the security level written in the wireless tag unit 51, and a document that is permitted to be copied is determined. That is, if the security level received from the server 42 is “Middle” and the security level written in the wireless tag unit 51 is “Middle” or “Low”, it is determined that this user can handle a confidential document or normal document. Then, the copy operation is executed in step S10, and when the copying is completed, the processing shifts to an end step S13.

Meanwhile, if the security level received from the server 42 is “Middle” and the security level written in the wireless tag unit 41 is “High”, it is determined that this user is not entitled to handle a top-secret document, and the processing shifts from step S9 to step S11. A message “Copying of this document is prohibited” is displayed on the display unit 13 and the copy operation is stopped. Also, as shown in step S12, a notification that execution of unauthorized copying is attempted may be sent to the document manager read from the wireless tag unit 51. For example, if the manager terminal 43 is the document manager terminal, the document manager can be notified of the attempt to execute unauthorized copying.

Thus, copying of a permitted document can be carried out after determining whether the user is a regular user or not and determining the type of the function permitted to the user. Steps S7 to S12 in FIG. 5 show the flow in the case of executing copying, but in the case of executing the other functions than copying, the processing shifts from step S6 to step S14 and the processing (and determination) similar to steps S7 to S12 is carried out for the other permitted functions (for example, mailing function, filing function, fax function).

Using the data of the preparation date and time of the wireless tag unit 52, it is possible to enable duplication of documents for which a predetermined period has passed from the document preparation date. Alternatively, data representing a confidentiality keeping period during which duplication is prohibited may be stored, instead of the data of the preparation date and time.

Thus, in this invention, in the case of reading an original and carrying out processing to copy, file or send it, the information in the wireless tag unit 51 attached to the original is read and it can be instantly determined whether the original can be duplicated or not. Thus, unauthorized access can be prohibited. Moreover, since whether duplication of an original is permitted or not can be controlled for each user, detailed management can be done.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image forming apparatus comprising:
a reading unit configured to read, from an original having a wireless tag unit attached thereto, an original image and data stored in the wireless tag unit;
a duplicating unit configured to perform duplication processing of the original image read by the reading unit;
a database in which user information including first data representing a security level for user is registered for each user who can use the image forming apparatus;
an authenticating unit configured to perform user authentication based on the user information registered in the database when a user executes duplication of the original; and
a control unit configured to determine, when second data representing a security level for management is stored in the wireless tag unit, whether duplication of the original is permitted or not on the basis of the result of comparison of the first data with the second data and the result of the user authentication, and to control the duplicating unit;
wherein when duplication is permitted, control is made to carry out duplication using a preset processing function.

2. The image forming apparatus according to claim 1, wherein the reading unit comprises a scanner configured to read an original image from the original, and a wireless tag reader configured to read data stored in the wireless tag unit.

3. The image forming apparatus according to claim 1, wherein the image forming apparatus is connectable to a manager terminal via a network interface, and if a user who is not permitted to duplicate the original attempts to duplicate it, on the basis of the result of the user authentication or the result of comparison of the first data with the second data, the image forming apparatus notifies the manager terminal.

4. The image forming apparatus according to claim 3, wherein the manager terminal is a terminal of a document manager, and data of the document manager is further stored as the data stored in the wireless tag unit, and
if a user who is not permitted to duplicate the original attempts to duplicate it, the document manager is notified.

5. The image forming apparatus according to claim 1, wherein the image forming apparatus is connectable to a server via a network interface, and the database is provided in the server.

6. The image forming apparatus according to claim 1, wherein the security level for user registered in the database is expressed in plural stage levels, and one of the stage levels is set for each user.

7. The image forming apparatus according to claim 1, wherein in addition to the second data, a document preparation date or confidentiality keeping period is stored in the wireless tag unit.

8. A control method for an image forming apparatus comprising:
providing a duplicating unit configured to perform duplication processing of an original image;
registering user information including first data representing a security level for user in a database, for each user who can use the image forming apparatus;
performing user authentication based on the user information registered in the database when a user executes duplication of the original;
reading, from an original having a wireless tag unit attached thereto, an original image and data stored in the wireless tag unit;
determining, when second data representing a security level for management is stored in the wireless tag unit, whether duplication of the original is permitted or not on the basis of the result of comparison of the first data with the second data and the result of the user authentication, and controlling the duplicating unit; and
carrying out duplication using a preset processing function when duplication is permitted.

9. The control method for an image forming apparatus according to claim 8, wherein the image forming apparatus is connected to a manager terminal via a network interface, and
if a user who is not permitted to duplicate the original attempts to duplicate it, on the basis of the result of the user authentication or the result of comparison of the first data with the second data, the manager terminal is notified.

10. The control method for an image forming apparatus according to claim 9, wherein the manager terminal is a terminal of a document manager, and the wireless tag unit further stores data of the document manager, and if a user who is not permitted to duplicate the original attempts to duplicate it, the document manager is notified by using the data of the document manager stored in the wireless tag unit.

11. The control method for an image forming apparatus according to claim 8, wherein security levels for user expressed in plural stage levels are registered in the data base, and a security level of one of the stages is set for each user.

12. The control method for an image forming apparatus according to claim 8, wherein in addition to the second data, a document preparation date or confidentiality keeping period is stored in the wireless tag unit.

13. A document management system adapted for attach a wireless tag unit to an original and manage the original using data stored in the wireless tag unit, comprising:
a reading unit configured to be capable of reading an original image and the data stored in the wireless tag unit;
a duplicating unit configured to perform duplication processing of the original image read by the reading unit;
a server in which user information including preset user data and first data representing a security level for each user is registered;
an authenticating unit configured to perform user authentication based on the user information registered in the database when a user executes duplication of the original; and
a control unit configured to determine, when second data representing a security level for management is stored in the wireless tag unit, whether duplication of the original is permitted or not on the basis of the result of comparison of the first data with the second data and the result of the user authentication, and to control the duplicating unit;
wherein execution of duplication is enabled using a preset processing function for a user who is permitted to duplicate.

14. The document management system according to claim 13, wherein the document management system includes a manager terminal connected via a network interface, and if a user who is not permitted to duplicate the original attempts to duplicate it, on the basis of the result of the user authentication or the result of comparison of the first data with the second data, the manager terminal is notified.

15. The document management system according to claim 14, wherein the manager terminal is a terminal of a document manager, and data of the document manager is further stored as the data stored in the wireless tag unit, and
if a user who is not permitted to duplicate the original attempts to duplicate it, the document manager is notified.

16. The document management system according to claim 13, wherein type data representing the type of duplication processing function set for each user is further registered as the user information in the database, and
the control unit discriminates a processing function permitted to an authenticated user on the basis of the type data, and controls execution of duplication using the permitted processing function.

17. The document management system according to claim 16, wherein the duplicating unit includes a printer and has a copy function of copying, by the printer, an original image read by the reading unit, as the duplication processing function.

18. The document management system according to claim 16, wherein the document management system includes an external device connected via a network interface, and the duplicating unit has a communication function of sending an original image read by the scanner, by e-mail or facsimile.

19. The document management system according to claim 16, wherein the document management system includes a storage device and is connectable to an external device via a network interface, and the duplicating unit has a filing function of taking an original image read by the reading unit, into the storage device or the external device.
